(19) United States
(12) Patent Application Publication
(10) Pub. No.: US 2017/0045167 A1
(43) Pub. Date: Feb. 16, 2017

(54) PIPE JOINT FOR PLASTIC PIPES

(71) Applicant: CONTECH ENGINEERED SOLUTIONS LLC, West Chester, OH (US)

(72) Inventors: Timothy J. Cormier, Cincinnati, OH (US); William L. Zepp, Sunbright, IN (US); Darrell J. Sanders, Mason, OH (US)

(73) Assignee: CONTECH ENGINEERED SOLUTIONS LLC, West Chester, OH (US)

(21) Appl. No.: 15/232,988

(22) Filed: Aug. 10, 2016

Related U.S. Application Data
(60) Provisional application No. 62/204,623, filed on Aug. 13, 2015.

(51) Int. Cl. F16L 23/18; F16L 23/036

(52) U.S. Cl. CPC F16L 23/18; F16L 23/036

(57) ABSTRACT

A pipe joint includes a first pipe and a second pipe. The first pope has a first annular flange at one end, the first annular flange including a first end face. The second pipe has a second annular flange at one end, the second annular flange including a second end face. The first annular flange is mated to the second annular flange, with the first end face and the second end face facing each other and pressing at least one seal member therebetween. A plurality of axial retaining members are disposed around a perimeter of the mated first and second annular flanges to hold the pipe joint together.

### TECHNICAL FIELD

This application relates generally to pipe joints and, more specifically, to a pipe joint for plastic pipes.

### BACKGROUND

Pipe joints used in plastic pipes (e.g., smooth-walled plastic pipe, ribbed plastic pipe, corrugated plastic pipe or steel reinforced plastic pipe) commonly utilize a bell and spigot configuration. U.S. Pat. No. 8,109,540, owned by the assignee of the present application, is exemplary of one such pipe joint.

Improvements in manufacturability, ease of in-field installation and/or performance are still sought.

### SUMMARY

In one aspect, a pipe joint includes a first pipe and a second pipe. The first pope has a first annular flange at one end, the first annular flange including a first end face. The second pipe has a second annular flange at one end, the second annular flange including a second end face. The first annular flange is mated to the second annular flange, with the first end face and the second end face facing each other and pressing at least one seal member therebetween. A plurality of retention members are disposed around a perimeter of the mated first and second annular flanges to hold the pipe joint together.

In another aspect, a plastic pipe is configured to produce a desirable pipe joint when mated with another pipe. The plastic pipe includes a tubular plastic member, and an annular flange at one end of the tubular plastic member. The annular flange includes an end face with a radially inner face portion, and a radially outer face portion that is axially offset from the radially inner face portion. The radially inner face portion lies in a first plane that is perpendicular to an elongated axis of the tubular member, and the radially outer face portion lies in a second plane that is perpendicular to the elongated axis. The end face includes an angled face portion that joins the radially inner face portion and the radially outer face portion. One or more seals may be connected to the end face.

In another aspect a plastic pipe is configured to produce a desirable pipe joint when mated to another pipe. The plastic pipe includes a tubular plastic member with a first annular flange at a first end of the tubular plastic member and defining a first end face. A second annular flange is positioned at a second end of the tubular plastic member and defines a second end face with a circumscribing projection with a T-shaped profile.

In a further aspect, a method of joining plastic pipe ends involves the steps of: utilizing a first plastic pipe having a first annular flange at one end, the first annular flange including a first end face; utilizing a second plastic pipe having a second annular flange at one end, the second annular flange including a second end face, the second end face configured for mating with the first end face; moving first end face and the second end face axially into mating relationship with each other; applying a plurality of axial retention members around a perimeter of the mated first and second annular flanges to hold the pipe joint together.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a side elevation of two pipes joined by one pipe joint embodiment;

FIG. 2 is a partial cross-section of the two pipe ends of FIG. 1 showing the pipe joint components before the pipes are joined; and

FIG. 3 is a partial cross-section of the two pipe ends showing the pipe joint components after the pipes are joined;

FIGS. 4 and 5A-5D depict another pipe joint embodiment;

FIGS. 6 and 7A-7B depict another pipe joint embodiment;

FIG. 8 depicts another pipe joint embodiment;

FIG. 9 depicts another pipe joint embodiment;

FIGS. 10-16 depict one embodiment of flange used in the pipe joint of FIG. 9;

FIGS. 17 and 18 depict another pipe joint embodiment;

FIG. 19 depicts one embodiment of a clamp component;

FIG. 20 depicts a clamp formed by assembling together four clamp components of the type depicted in FIG. 19;

FIGS. 21-24 depict a pipe joint embodiment utilizing the clamp assembly of FIG. 20; and

FIG. 25 depicts a side elevation of a pipe joint with circumferentially spaced apart axial retention members.

### DETAILED DESCRIPTION

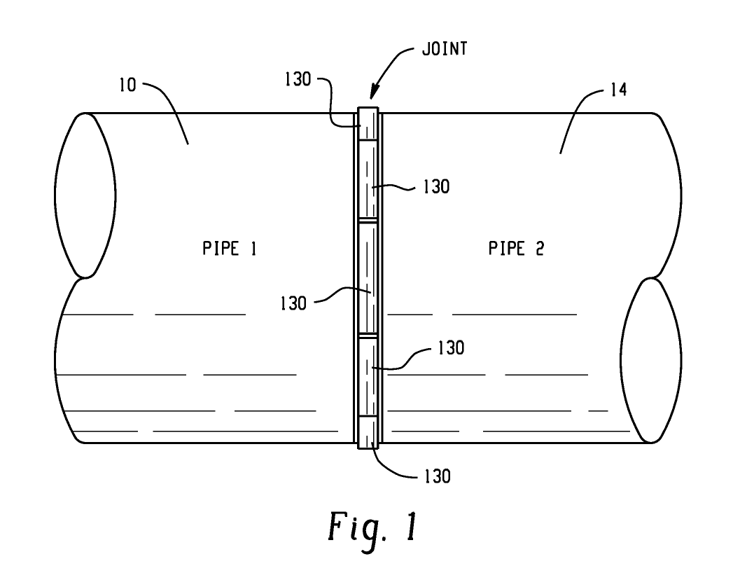

Referring to FIGS. 1-3, a pipe joint assembly includes axially mating annular flanges 100, 102, each of which is located at one end of a respective pipe 10, 14. Each annular flange may be formed by extrusion of a suitable plastic, such as high density polyethylene (HDPE). Where additional joint strength is needed, the extrusion material may incorporate glass fiber. The extrusions are then cut to desired length and cold formed and hot plate welded into annular form of desired diameter. For larger diameter pipe multiple extrusions could be but welded together and then fold formed and hot plate welded. The annular flanges are then welded to pipe ends at pipe insert wings 104, 106. The pipes may be of any plastic configuration, such as ribbed, corrugated, steel-reinforced or smooth-walled. As an alternative to extrusion, the flanges could also be molded as a single piece or multiple molded radiused sections could be assembled together to form the flanges.

Annular flange 100 includes a pair of radially spaced apart inner and outer slots 108, 110 into which mount lips of radially inner and outer seals 112, 114 can be inserted to hold the seals in place. Notably, annular flange 100 is formed with axially offset radially inner and outer end face portions 116 and 118, which results in an axial offset of the position of the seals 112, 114. Annular flange 102 includes axially offset radially inner and outer end face portions 120 and 122 shaped to mate with portions 116 and 120 of flange 100.

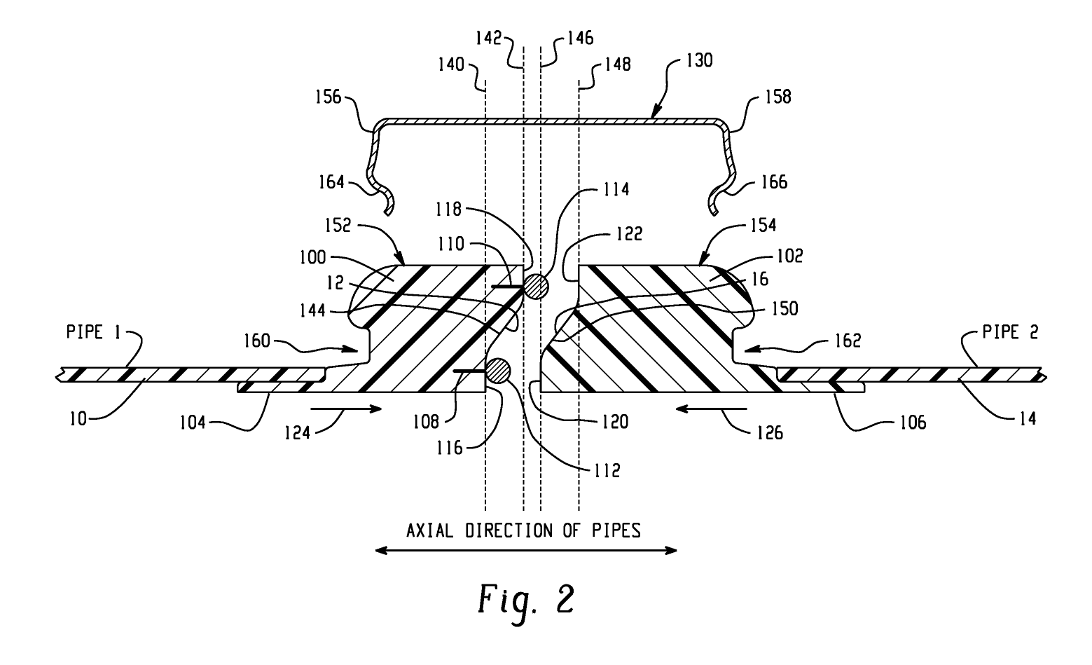

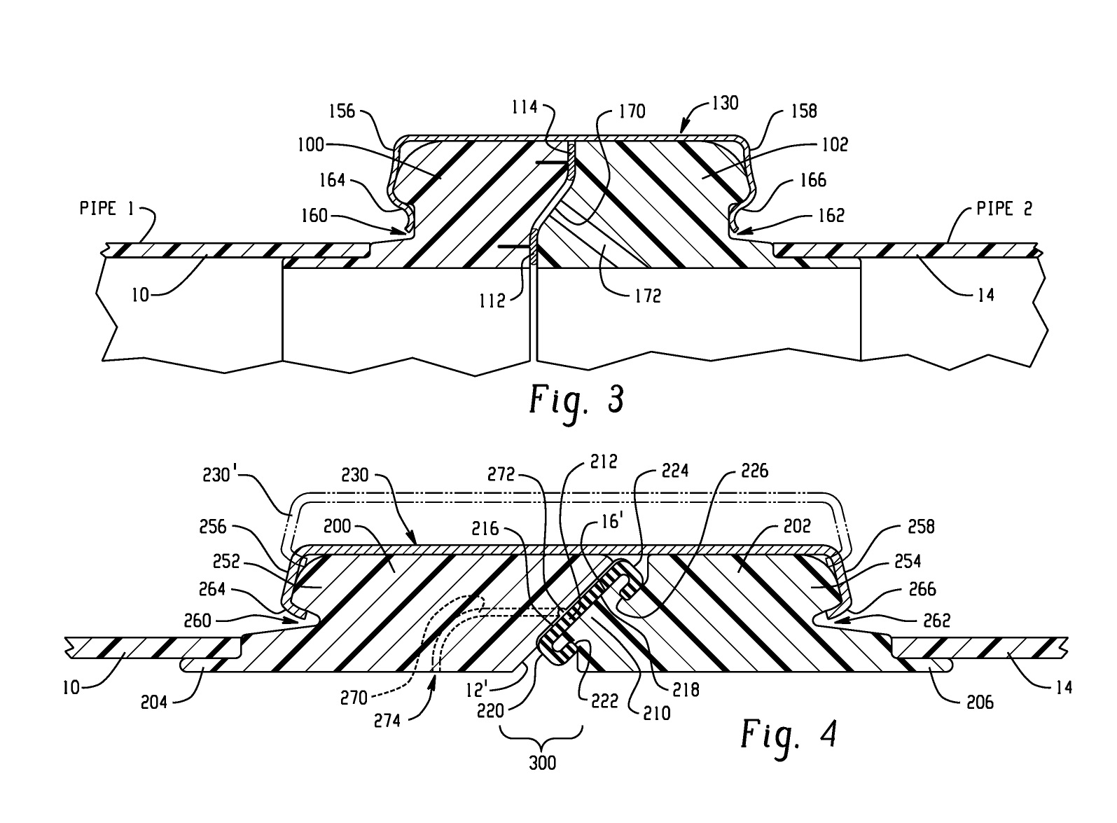

To complete a joint in the field, the two pipe ends are moved axially together per arrows 124, 126 in FIG. 2 so that the seals 112, 114 become axially compressed as shown in FIG. 3. Once the flanges 100, 102 and seals 112, 114 are axially compressed together, a plurality of stainless steel snap-fit clips/covers 130 are snap-fitted about the flanges to maintain the mating compression of the joint. The snap-covers are placed circumferentially end to end about the entire periphery of the joint as best seen in FIG. 1, though some spacing between each snap-cover may exist.

More specifically, the illustrated embodiment provides a pipe joint with the following configuration. A first pipe 10 has annular flange 100 at one end, the annular flange 100 including an end face 12. A second pipe 14 has annular flange 102 at one end, the annular flange 102 including an end face 16. The annular flange 100 is mated to the annular flange 102, in the illustrated case with the end face 12 abutting against the end face 16, to press at least one seal member (in this case two seal members 112 and 114) therebetween. A plurality of snap-fit compression clips 130 are disposed around a perimeter of the mated annular flanges 100 and 102 to hold the pipe joint together.

As shown, end face 12 includes a radially inner face portion 116, and a radially outer face portion 118 that is axially offset from radially inner face portion 116. Radially outer face portion 118 is located further toward a distal end of the pipe 10, and in this case actually forms the most distal portion of the pipe 10. End face 16 includes a radially inner face portion 120, and a radially outer face portion 122 that is axially offset from the radially inner face portion 120. Radially inner face portion 120 is located further toward a distal end of the pipe 14, and in this case forms the most distal portion of the pipe 14. Seal member 112 is compressed between the radially inner face portion 116 and the radially inner face portion 120, and seal member 114 is compressed between the radially outer face portion 118 and the radially outer face portion 122. The arrangement is such that the seal member 112 and the seal member 114 are axially offset from each other.

Radially inner face portion 116 lies in a plane 140 that is perpendicular to an elongated axis of the pipe 10, and radially outer face portion lies in a plane 142 that is perpendicular to the elongated axis of pipe 10. An angled face portion 144 joins the radially inner and outer face portions. Radially inner face portion 120 lies in a plane 146 that is perpendicular to an elongated axis of the pipe 14, and radially outer face portion 122 lies in a plane 148 that is perpendicular to the elongated axis of pipe 14. An angled face portion 150 joins the radially inner and outer face portions 120 and 122. When the annular flanges are mated to form the pipe joint, planes 140 and 148 become substantially coplanar, and planes 142 and 148 become substantially coplanar.

Annular flange 100 includes a radially outward projecting body 152, and annular flange 102 includes a second radially outward projecting body 154. One side 156 of each snap-fit compression clip snaps onto the radially outward projecting body 152 and the other side 158 of each snap-fit compression clip snaps onto the radially outward projecting body 154. In the illustrated embodiment, one edge of the radially outward projecting body 152 defines an annular groove 160 facing axially away from the end face 12, and one edge of the radially outward projecting body 154 defines an annular groove 162 facing axially away from the end face 16. Side 156 of each snap-fit compression clip 130 includes a finger portion 164 that snaps into the annular groove 160 and side 158 of each snap-fit compression clip 130 includes a finger portion 166 that snaps into the annular groove 162.

While the annular flanges may be formed of plastic (e.g., HDPE or other plastic), each snap-fit compression clip may formed by a contoured metal plate (e.g., stainless steel or aluminum, either of which may be coated to resist corrosion), which provides the desired strength and resilience to hold the joint together while providing good axial compression of the flanges. Other material options for the clips include reinforced plastic or composite materials. In one example, each snap-fit compression clip 130 is of elongate arcuate shape that extends through no more than sixty degrees (e.g., between 35 degrees and 55 degrees), but variations are possible.

As shown in FIG. 3, the end face of one of the annular flanges may include a port 170 opening to a sealing space between the seal members 112 and 114. This port may be used to enable pressurization of the sealing space for seal testing once the joint is fully assembled in the field. The port 170 includes a passage 172 that extends to an interior surface of the annular flange as shown. However, the passage could extend to an exterior surface of the annular flange. In such a case, the snap-fit compression clip 130 that overlies the passage could include a through opening that aligns with the passage to enable access to the passage. The passage could be suitably plugged after pressure testing of the joint, or could include an integrated valve that eliminates the need for plugging after the in-field pressure test.

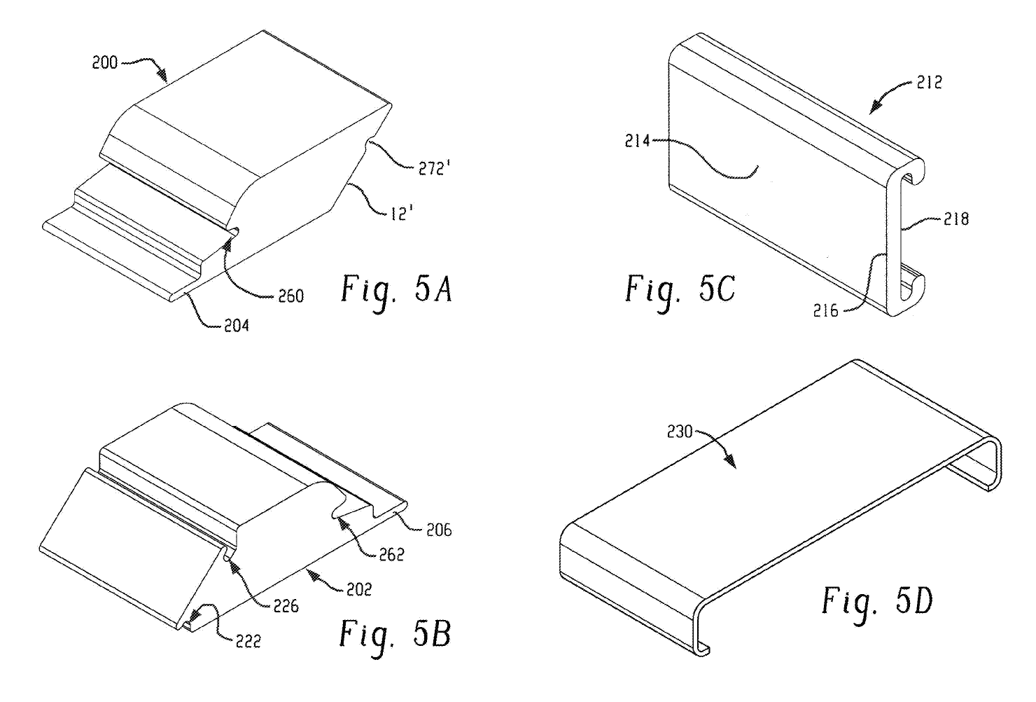

Reference is now made to the embodiment of FIGS. 4 and 5A-5D, where FIG. 4 shows a partial cross-section of a made-up joint and FIGS. 5A-5D show perspective views of short segments of the components making up the joint. The pipe joint assembly includes axially mating annular flanges 200, 202, each of which is located at one end of a respective pipe 10, 14. In fully assembled form the joint will have an appearance much the same as that in FIG. 1. Returning to FIGS. 4 and 5A-5D, as with the embodiment above, each annular flange may be formed by extrusion of a suitable plastic, such as high density polyethylene (HDPE), which is then curved in annular form with abutting ends joined (e.g., plastic weld). Where additional joint strength is needed, the extrusion material may incorporate glass fiber. The extrusions are cut to desired length and cold formed and hot plate welded into annular form of desired diameter. Multiple extrusions could be combined or the aforementioned molding options are also possible. The annular flanges are then welded to pipe ends at pipe insert wings 204, 206, which insert wings sit radially within the pipe. The pipes may be of any plastic configuration, such as ribbed, corrugated, steel-reinforced or smooth-walled.

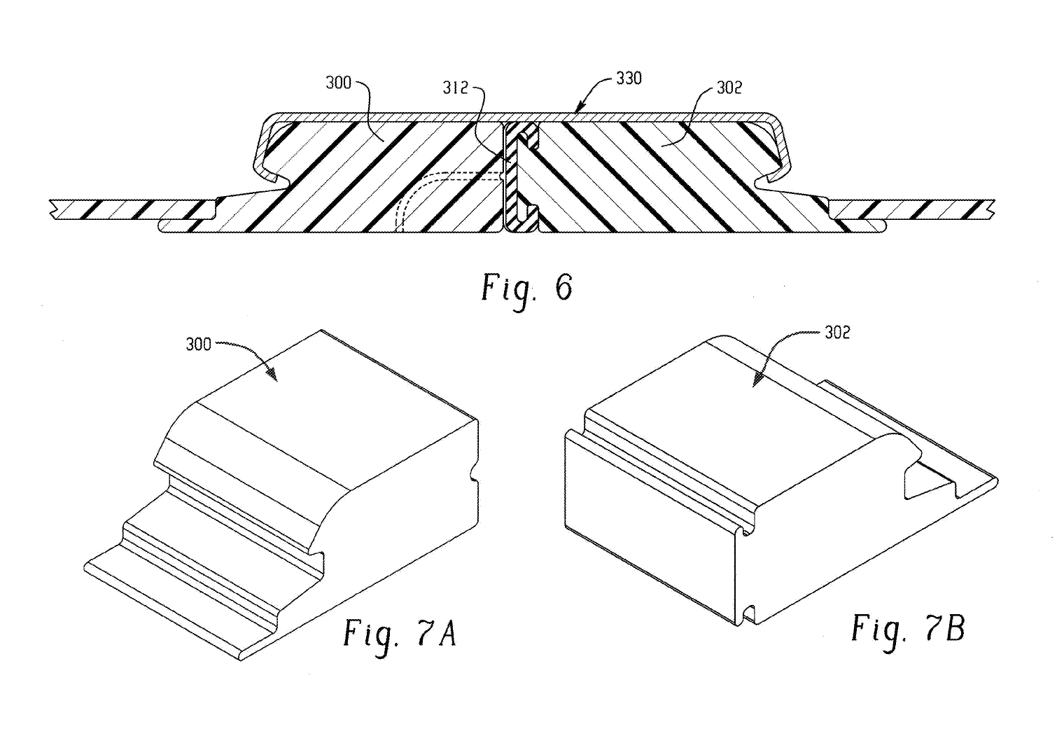

Annular flange 200 has an end face 12′ that defines a tapered mating zone 300. End face 12′ is tapered radially inwardly when moving from the end of the flange toward the body of pipe 10. Annular flange 202 includes an end face 16′ that is tapered to be received within the tapered mating zone 300. End face 16′ is tapered radially outwardly when moving from the end of the flange toward the body of pipe 14. The tapered arrangement aids in in-field fit-up. However, as reflected in the embodiment of FIGS. 6 and 7A-7B, it is contemplated that in some implementations the taper need not be used.

Referring again to FIGS. 4 and 5A-5D, end face 16′ includes a circumscribing projection 210 with a T-shaped cross-sectional profile (where the cross-section is taken in a plane in which the longitudinal center axis of the pipe lies). The projection 210 acts a seal receiver. A seal member 212, which is of annular configuration, is formed with C-shaped cross-sectional profile that mounts to the T-shaped profile of the circumscribing projection 210. The seal member 212 is flexible or pliable enough to be manually removable from the circumscribing projection, and likewise manually installable in the field. The seal member may, in one example, be extruded as a straight piece (e.g., see the seal segment of FIG. 5C) and then curved and ends joined (e.g., plastic weld) to form the desired annular seal member configuration. A single or multi-piece mold process could also be used to form the seal member 212.

Notably, the seal member 212 includes a substantially planar annular portion 214 having opposed sealing faces 216 and 218. Sealing face 216 engages the end face 12′ and sealing face 218 engage end face 16′ for joint sealing purposes. The seal member 212 includes a radially inner edge portion 220 with a finger engaged with a radially inner groove 222 of the end face 16′, and a radially outer edge portion 224 with a finger engaged with a radially outer groove 226 of the end face 16′ to releasably hold the seal member to the end face 16′.

To complete a joint in the field, the two pipe ends are moved axially together into the position reflected by FIG. 4, so that the seal member 212 becomes axially pressed between the two end faces 12′ and 16′. A plurality of stainless steel (or other suitable material as noted above) snap-fit compression clips 230 are snap-fitted about the flanges to maintain the mating compression of the joint. By way of example, each clip may be positioned by initially placing the clip against the joined flanges in a position generally reflected by dashed line 230′ of FIG. 4. The clip is then hammered radially inward against the joined flanges so that the clip snaps into mated engagement with the flanges. The snap-fit clips may be placed circumferentially end to end about the entire periphery of the joint as best seen in FIG. 1, though some spacing between each snap-fit clip may exist.

Annular flange 200 includes a radially outward projecting body 252, and annular flange 202 includes a radially outward projecting body 254. One side 256 of each snap-fit compression clip or cover snaps onto the radially outward projecting body 252 and the other side 258 of each snap-fit compression clip snaps onto the radially outward projecting body 254. In the illustrated embodiment, one edge of the radially outward projecting body 252 defines an annular groove 260 facing axially away from the end face 12′, and one edge of the radially outward projecting body 254 defines an annular groove 262 facing axially away from the end face 16′. Side 256 of each snap-fit compression clip 230 includes a finger portion 264 that snaps into the annular groove 260 and side 258 of each snap-fit compression clip 230 includes a finger portion 266 that snaps into the annular groove 262. Preferably the snap-fit clip has sufficient rigidity that it is effectively permanently attached once hammered in place (e.g., cannot be removed by hand), though variations are possible. The clips aid in maintaining the integrity of the seal and alignment of the joined pipes.

While the annular flanges may be formed of plastic (e.g., HDPE or other plastic), each snap-fit compression clip 230 may formed by a contoured metal plate (e.g., stainless steel or aluminum, either of which may be coated to resist corrosion), which provides the desired strength and resilience to hold the joint together while providing good axial compression of the flanges. Other material options for the clips include reinforced plastic or composite materials. In one example, each snap-fit compression clip 230 is of elongate arcuate shape that extends through no more than sixty degrees (e.g., between 35 degrees and 55 degrees), but variations are possible.

In some embodiments, end face 12′ may include a port 270 opening to a void space 272 adjacent the seal member 212 to enable pressurization of the void space 272 for seal testing. The void spaced is formed by a recessed groove 272′ on the end face 12′, and is thus annular in nature, and the port includes a passage that extends to an interior surface of the flange 200 (e.g., at location 274). A continuous seal is created with the gasket or seal member 212 on both sides of the void space 272. The port provides access to the void space to an operator working inside the pipe after the joint is assembled. Access to the void space allows an operator/installer to inject compressed air or other medium into the void space for the purposes of assuring the adequacy of the seal between the two parts. Also, a chemical sealant could be injected to fill the void space between the parts to help establish or enhance the seal between the two pipes.

Referring to the embodiment of FIGS. 6 and 7A-7B, the joint configuration is similar to that of the joint of FIG. 4 above, except that the end faces 12″ and 16″ of the flanges are not tapered. In this case the planar portion of the seal member 312 extends substantially radially when the joint is made up as shown and the clips 330 are applied. Otherwise, the features of the joint of FIG. 6 are comparable to the joint of FIG. 4.

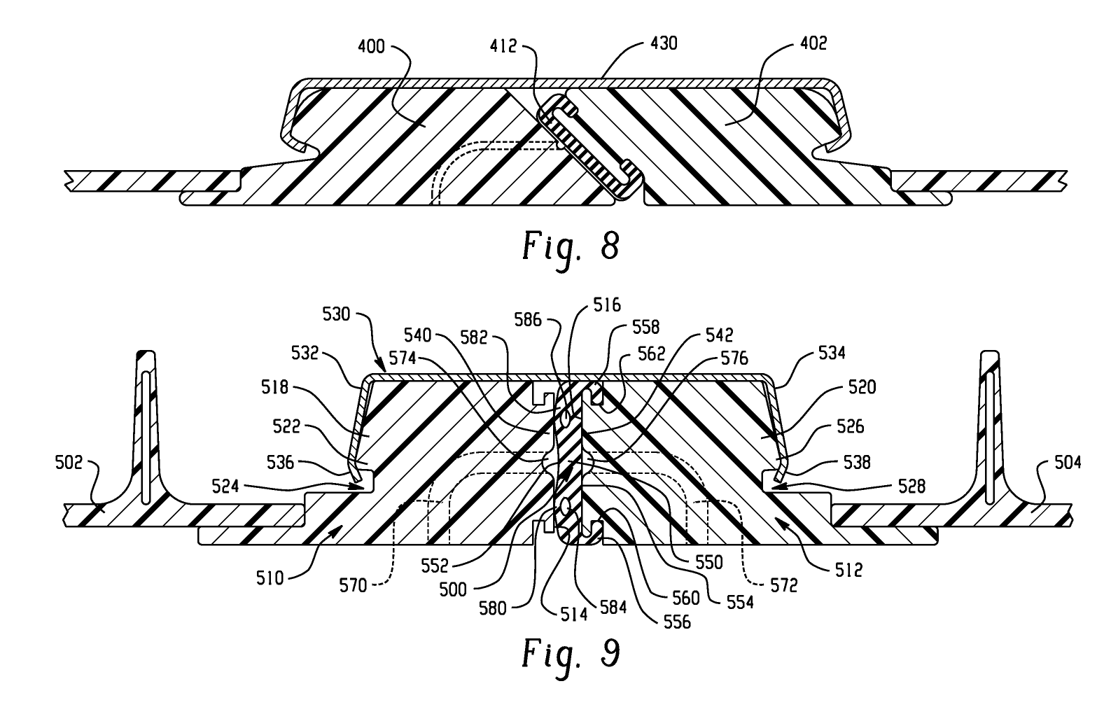

FIG. 8 depicts another tapered embodiment in which the end face of flange 402 tapers radially inward, the end face of flange 400 tapers radially outward and the seal member 412 faces generally radially inward when applied. In other respects the embodiment of FIG. 8 is similar to the embodiment of FIG. 4.

Referring now to FIG. 9, another embodiment of a pipe joint assembly configuration is shown. The configuration includes a pipe 502 having annular flange 510 at one end, the flange 510 including end face 514, and a pipe 504 having an annular flange 512 at one end, the flange 512 including an end face 516. The annular flange 510 is mated to the annular flange 512, with the end face 514 and the end face 516 facing each other and pressing at least one seal member 500 therebetween. A plurality of snap-fit compression clips 530 (one shown) are disposed around a perimeter of the mated flanges 510 and 512 to hold the pipe joint together. In the illustrated embodiment, the pipes 502 and 504 are steel reinforced polyethylene with upstanding ribs that incorporated the steel reinforcement, but other pipe types are contemplated as described above.

Notably, in this embodiment the flanges 510 and 512 are of a like configuration. Each flange 510 and 512 includes a respective radially outward projecting body 518 and 520, and one side 532 of each snap-fit compression clip 530 snaps onto the radially outward projecting body 518 and the other side 534 of each snap-fit compression clip 530 snaps onto the radially outward projecting body 520. Edge 522 of the radially outward projecting body 518 defines an annular groove 524 facing axially away from the end face 514, and edge 526 of the radially outward projecting body 520 defines an annular groove 528 facing axially away from the end face 516. Side 532 of each snap-fit compression clip includes a finger portion 536 that snaps into the annular groove 524 and side 534 of each snap-fit compression clip includes a finger portion 538 that snaps into the annular groove 528.

Each flange end face 514 and 516 includes a circumscribing projection 540 and 542 with a T-shaped profile. The seal member 500 is formed with C-shaped profile that can mount to the T-shaped profile of either circumscribing projection. In the illustrated embodiment seal member 500 mounts to projection 542 and projection 540 does not include a mounted seal member. However, in other embodiments both projections 540 and 542 could include respective seal members.

The seal member 500 may be flexible and manually removable from the circumscribing projection 542. The seal member 500 includes a substantially planar annular portion 550 having opposed sealing faces 552 and 554, where sealing face 552 engages end face 514 and sealing face 554 engages end face 516. The seal member 500 includes a radially inner edge portion 556 engaged with a groove 560 of the end face 516 (formed by the radially inner portion of the T-shaped profile) and a radially outer edge portion 558 engaged with a groove 562 of the end face (formed by the radially outer portion of the T-shaped profile) to releasably hold the seal member 500 onto the end face 516.

Each end face 514 and 516 may include a respective port 570 and 572 opening to a void space 574 and 576 adjacent the seal member 530 to enable pressurization of the void space for seal testing. Here, the end faces 514 and 516 each include axial recesses along the head portion of each T-shaped profiled to help form the void spaces, each void space is generally annular and the ports 570 and 572 include respective passages that extend to an interior surface of the respective flange. The illustrated seal member 500 includes radially spaced apart compression portions 580 and 582 that may each align with respective internal passages 584 and 586 formed within the seal member, where the passages increase the flexibility of the compression portions 580 and 582 to permit more compression when the joint is tightly assembled.

The flanges, seal members and compression clips of the joint assembly of FIG. 9 may be formed of respective materials similar to those described above with respective to the above joint assemblies.

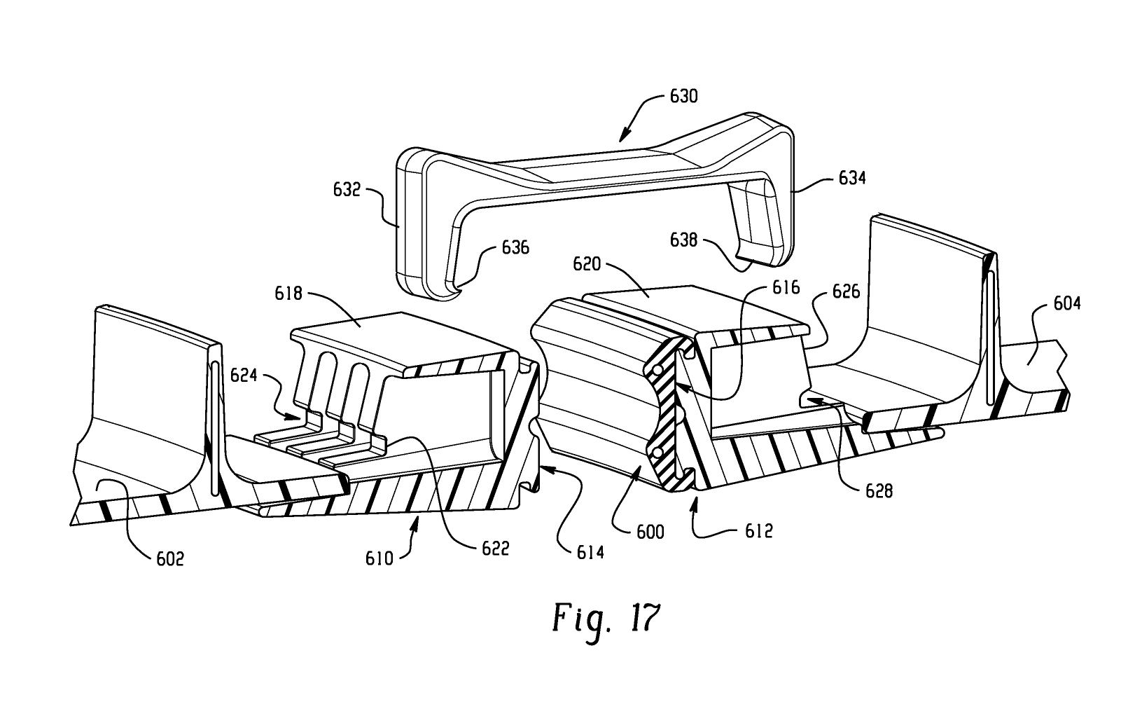

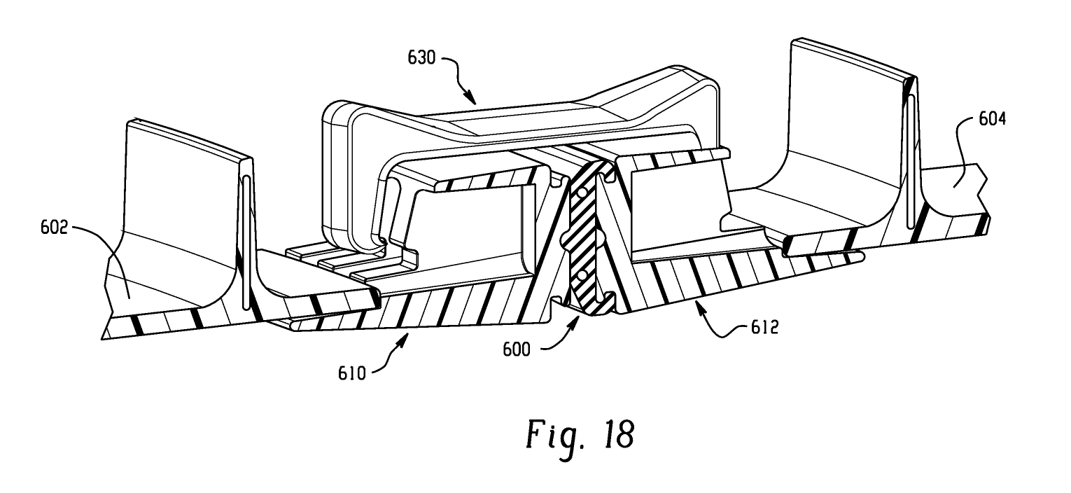

Referring to FIGS. 17 and 18, another embodiment of a pipe joint assembly configuration is shown. The configuration includes a pipe 602 having annular flange 610 at one end, the flange 610 including end face 614, and a pipe 604 having an annular flange 612 at one end, the flange 612 including an end face 616. The annular flanges 610 and 612 are similar to annular flanges 510 and 512 describe above and are similarly mated together. A plurality of snap-fit compression clips 630 (one shown) are disposed around a perimeter of the mated flanges 610 and 612 to hold the pipe joint together.

Each flange 610 and 612 includes a respective radially outward projecting body 618 and 620, and one side 632 of each snap-fit compression clip 630 snaps onto the radially outward projecting body 618 and the other side 634 of each snap-fit compression clip 630 snaps onto the radially outward projecting body 620. Edge 622 of the radially outward projecting body 618 defines an annular groove 624 facing axially away from the end face 614, and edge 626 of the radially outward projecting body 620 defines an annular groove 628 facing axially away from the end face 616. Side 632 of each snap-fit compression clip includes a finger portion 636 that snaps into the annular groove 624 and side 634 of each snap-fit compression clip includes a finger portion 638 that snaps into the annular groove 628. Each flange end face includes a circumscribing projection with a T-shaped profile as described above, and the seal member 600 is similar to seal member 500 described above in terms of configuration and engagement with the T-shaped profile.

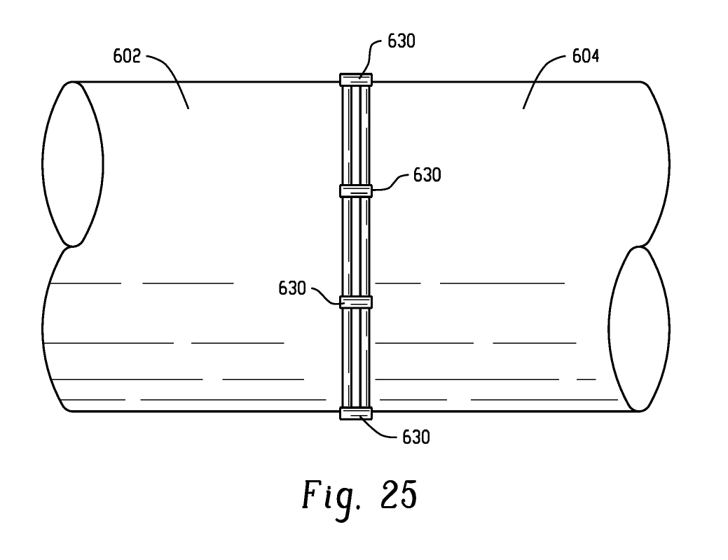

The compression clips of the joint assembly of FIGS. 17 and 18 may be formed of metal material (e.g., cast iron or steel), but other materials could also be used. The compression clips 630 are contemplated as relatively short in circumferential coverage dimension (e.g., no more than about eight inches, such as between about one inch and about 5 inches), though variations are possible. In such an arrangement a circumferential spacing between adjacent compression clips disposed about the pipe joint may be relatively large (e.g., on the order of at least one foot, such as between about one foot and about three feet). FIG. 25 depicts an example of such a spaced apart arrangement.

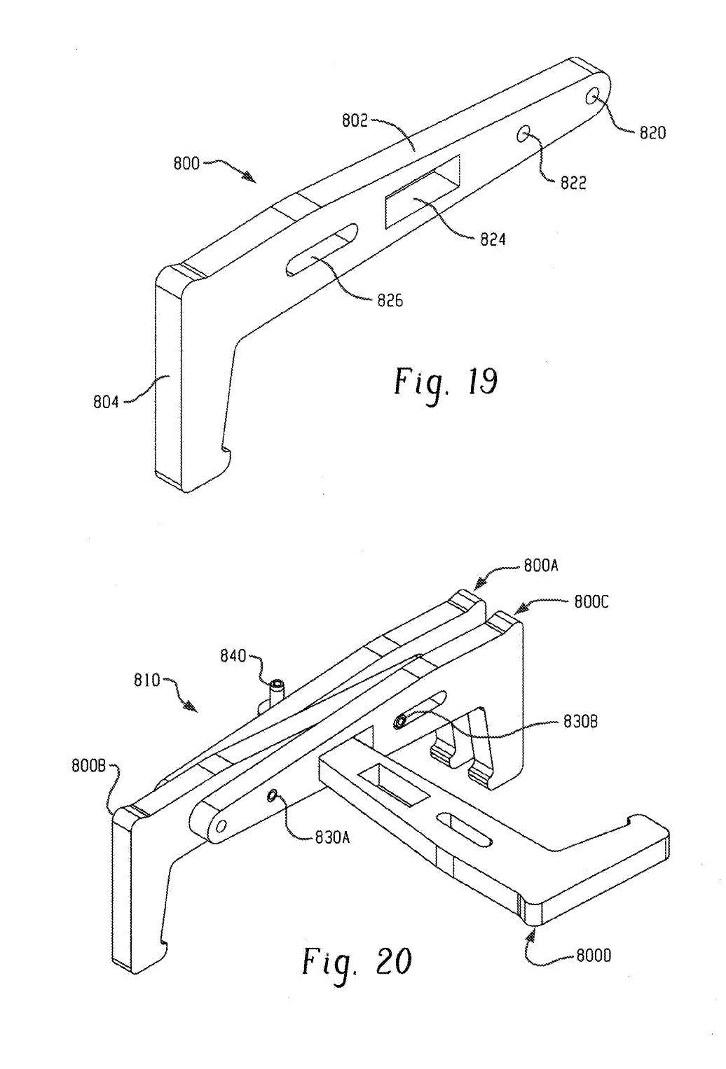

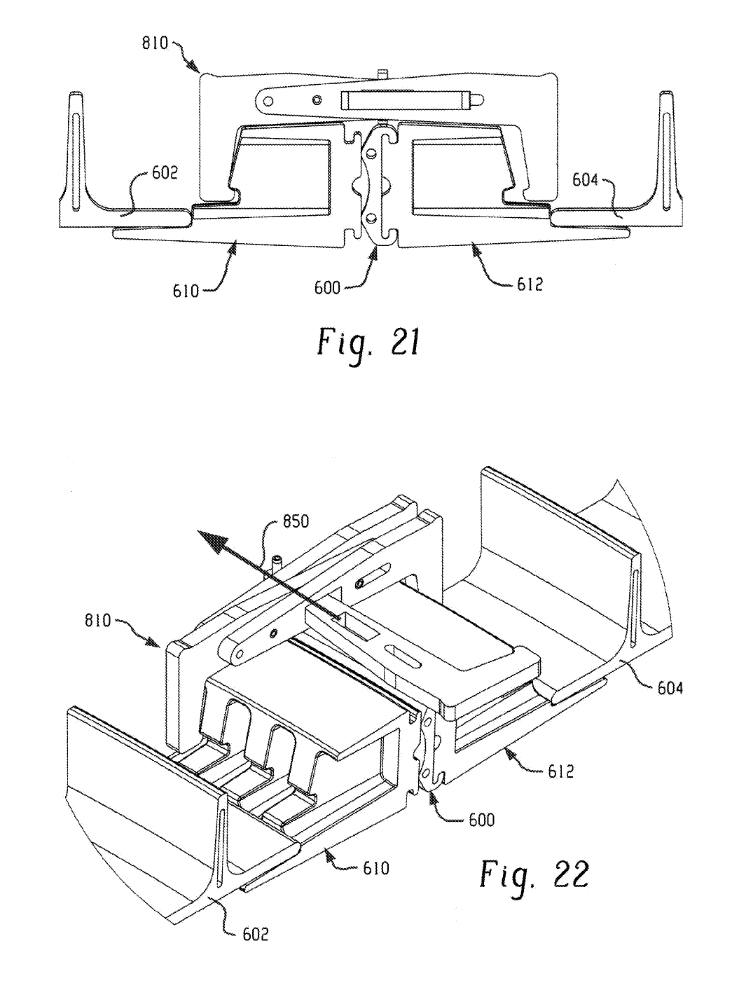

Although the above embodiments contemplate the use of axial retention members in the form of compression clips with no movable parts (e.g., clips that snap onto the pipe joint to hold the pipe joint together), it is recognized that in other variations axial retention members in the form clamp assemblies with moving parts could be utilized. In this regard, reference is made to FIGS. 19 and 20, where FIG. 19 shows a clamp component 800 and FIG. 20 shows a clamp assembly 810 formed by an assembly of four like clamp components 800A, 800B, 800C and 800D. Referring to FIG. 19, each clamp component includes an axial arm portion 802 and a leg portion 804, where the arm portion includes an end opening 820, and adjacent opening 822, a main adjustment slot 824 and an assembly slot 826.

In the assembled clamp of FIG. 20, clamp components 800A and 800C have a parallel and like axial orientation, with claim 800B disposed therebetween in an opposite axial orientation (e.g., with its axial arm portion projecting opposite the axial arm portions of clamp components 800A and 800C). Dow pins or locking screws 830A and 830B hold the components in side by side relation by passing through the aligned openings and slots (e.g., two openings 822 on respective sides of an intermediate slot 824 in the case of pin or screw 830A and two slots 824 on respective sides of an opening 822 in the case of pin or screw 830B). Clamp component 800D extends through the aligned assembly slots 826 of components 800A, 800B and 800C and may be held in place by a pin 840 in the end opening of the component 800D.

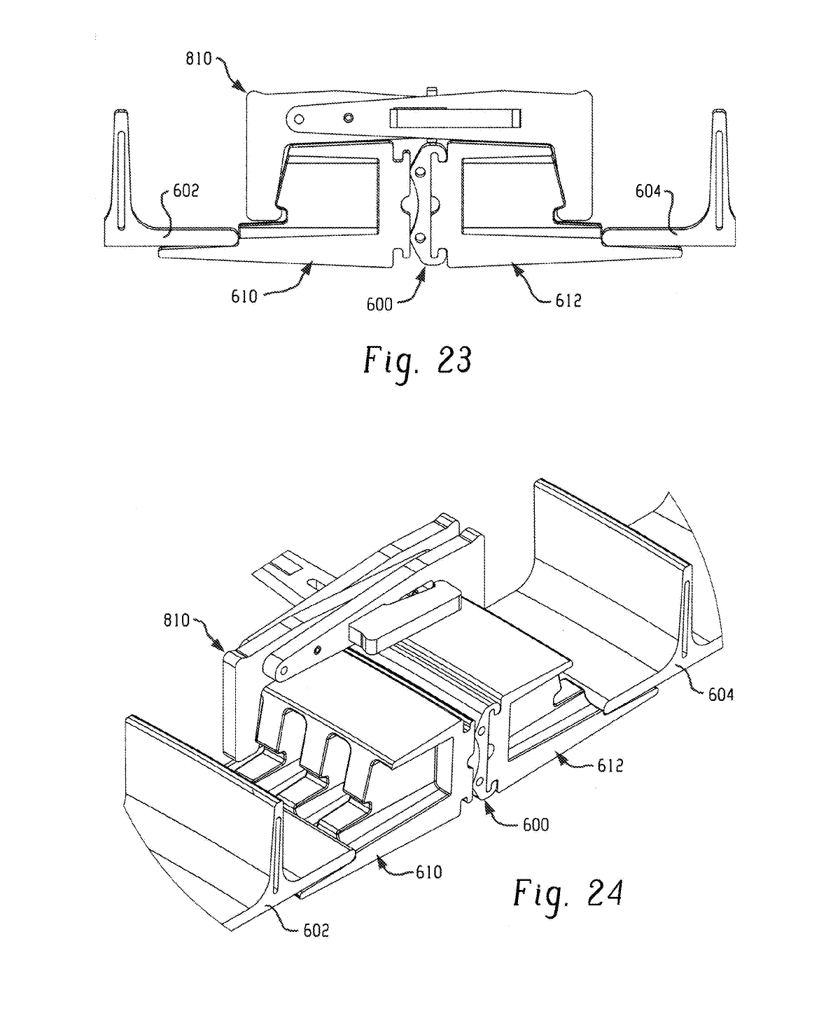

As seen in FIGS. 21-24, the clamp assembly acts as an axial retaining member in the case of a pipe joint (e.g., with pipes, end flanges and seal member as described above) and can be moved from a non-clamping configuration (e.g., FIGS. 21 and 22) to a clamping orientation (e.g., FIGS. 23 and 24) by moving clamp component 800D through the clamp assembly in the direction indicated by arrow 850 in FIG. 22 (e.g., by engaging the leg end of the clamp component 800D with a hammer). In this regard, the arm portion of the clamp component 800D is shaped to interact with the assembly slots to cause the clamp components 800A, 800B and 800C to move axially together. Notably, the leg portions of the clamp components 800A, 800B and 800C include finger portions that engage the flange slots upon clamping, as best seen in FIG. 23.

Utilizing flanges of the above-described joint embodiments provides a method of joining plastic pipe ends in the field. The method involves: utilizing a first plastic pipe having a first annular flange at one end, the first annular flange including a first end face; utilizing a second plastic pipe having a second annular flange at one end, the second annular flange including a second end face, the second end face configured for mating with the first end face; moving first end face and the second end face axially into mating relationship with each other; applying (e.g., by aligning and pressing radially inward or by positioning and adjusting) a plurality of axial retention members (e.g., snap-fit compression clips or clamp assemblies) around a perimeter of the mated first and second annular flanges to hold the pipe joint together. In certain embodiments (e.g., FIG. 3) the mating relationship may involve portions of the flange end faces being in abutting contact, while in other embodiments (e.g., FIGS. 4, 6, 8, 9, 18 and 23) the mating relationship may involve the end faces abutting sealing faces of the seal member (e.g., without the end faces contacting each other directly). In the case of snap-fit compression clips, no moving parts or fasteners are needed to hold the pipe joint together.

It is to be clearly understood that the above description is intended by way of illustration and example only, is not intended to be taken by way of limitation, and that other changes and modifications are possible. For example, while the illustrated pipes are shown with one end having an annular flange, it is recognized that both pipe ends will typically include an annular flange, with one end having a flange of type 100, 200, 300, 400, 500 and the other end having a mating flange of the type 102, 202, 302, 402, 502, though the flanges can be the same configuration as in the case of flange 500 and 502.

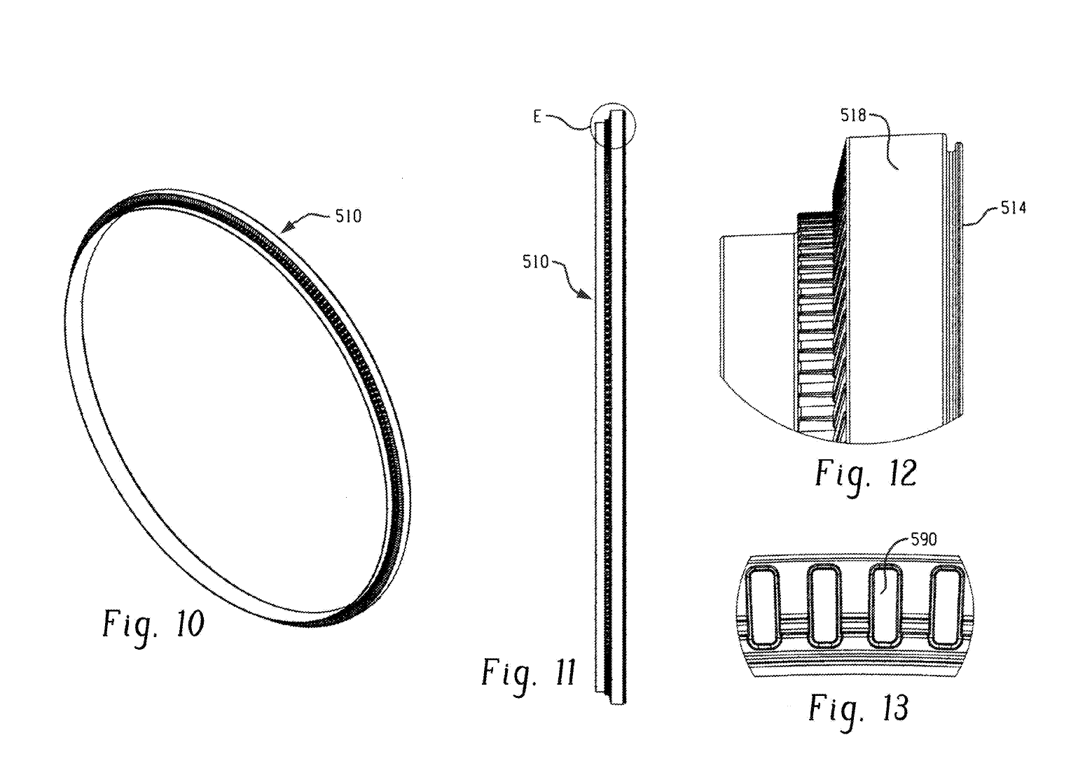

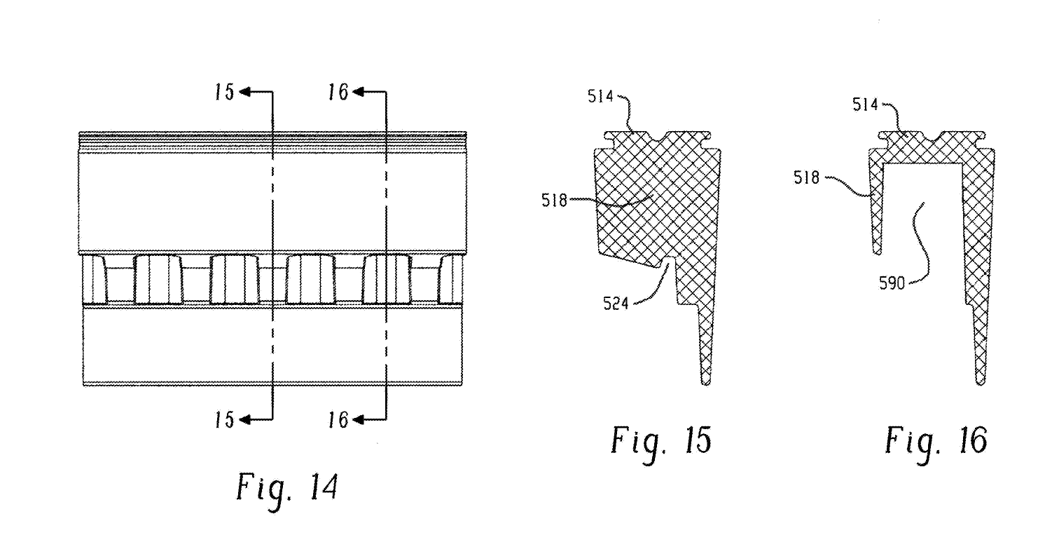

Moreover, while the joint components, primarily the flanges, are generally shown as solid in cross-section, it is recognized that in some embodiments internal void areas could be provided to decrease weight and material usage. Such void spaces may be particularly implemented where molding techniques are utilized to form the flanges, with the void spaces arranged and configured to facilitate mold fill, cooling of the molded component and/or removal of the molded component from the mold. In this regard, reference is made to FIGS. 10-16 showing an exemplary embodiment for annular flange 510 (or 512) of the joint assembly shown in FIG. 9. FIG. 12 depicts an enlarged view of region E of FIG. 11, and FIG. 13 depicts a partial elevation view looking at FIG. 12 from left to right. As seen in FIG. 12, a plurality of circumferentially spaced apart void spaces 590 are provided in the main body of the flange, each running both radially and axially toward the end face 514. The cross-sections shown in FIGS. 15 and 16 are taken along lines 15-15 and 16-16 of FIG. 14 respectively and further illustrated the configuration of the circumferentially spaced apart void spaces 590. It is recognized, however, that other void space configurations are possible.

1. A pipe joint, comprising:
a first pipe having a first annular flange at one end, the first annular flange including a first end face;
a second pipe having a second annular flange at one end, the second annular flange including a second end face;
the first annular flange mated to the second annular flange, with the first end face and the second end face facing each other and pressing at least one seal member therebetween; and
a plurality of retention members disposed around a perimeter of the mated first and second annular flanges to hold the pipe joint together.

2. The pipe joint of claim 1 wherein:
the first annular flange includes a first radially outward projecting body;
the second annular flange includes a second radially outward projecting body;
a first side of each retention member engages onto the first radially outward projecting body and a second side of each retention member engages onto the second radially outward projecting body.

3. The pipe joint of claim 2 wherein:
one edge of the first radially outward projecting body defines a first annular groove facing axially away from the first end face;
one edge of the second radially outward projecting body defines a second annular groove facing axially away from the second end face;
the first side of each retention member includes a finger portion that engages into the first annular groove and the second side of each retention member includes a finger portion that snaps into the second annular groove.

4. The pipe joint of claim 1 wherein:
each retention member is formed as one of a snap-fit compression clip or an axial clamp assembly.

5. The pipe joint of claim 4 wherein:
adjacent retention members are spaced apart from each other around the pipe joint by at least one circumferential foot.

6. The pipe joint of claim 4 wherein:
each retention member covers no more than about three circumferential inches of the pipe joint.

7. The pipe joint of claim 4 wherein:
the first annular flange is formed of plastic;
the second annular flange is formed of plastic;
each retention member is formed of one of metal, a reinforced plastic material or a composite material.

8. The pipe joint of claim 1 wherein at least one of the first end face or the second end face includes a circumscribing projection with a T-shaped profile, and the seal member is formed with C-shaped profile that mounts to the T-shaped profile of the circumscribing projection.

9. The pipe joint of claim 8, wherein the seal member is flexible and manually removable from the circumscribing projection.

10. The pipe joint of claim 1 wherein the seal member includes a substantially planar annular portion having opposed first and second sealing faces, the first sealing face engaged by the first end face and the second sealing face engaged by the second end face.

11. The pipe joint of claim 10 wherein the seal member includes a radially inner edge portion engaged with a first groove of the second end face and a radially outer edge portion engaged with a second groove of the second end face to releasably hold seal member to the second end face.

12. The pipe joint of claim 10, wherein at least one of the first end face and the second end face includes a port opening to a void space adjacent the seal member to enable pressurization of the void space for seal testing.

13. The pipe joint of claim 12 wherein the void space is annular and the port includes a passage that extends to an interior surface of the first annular flange or the second annular flange.

14. The pipe joint of claim 1 wherein the first end face defines a tapered mating zone, the second end face is tapered to be received within the tapered mating zone.

15. The pipe joint of claim 14 wherein the first end face is tapered radially inwardly, the second end face is tapered radially outwardly, and the seal member is releasably engaged with a seal mount projection on the second end face.

16. The pipe joint of claim 2 wherein the first radially outwardly projecting body includes a plurality of circumferentially spaced apart void spaces running radially and axially within the body.

17. A plastic pipe, comprising:
a tubular plastic member;
a first annular flange at a first end of the tubular plastic member and defining a first end face;
a second annular flange at a second end of the tubular plastic member and defining a second end face with a circumscribing projection with a T-shaped profile.

18. The plastic pipe of claim 17, further comprising a seal member with a C-shaped profile, the seal member mounted to the T-shaped profile of the circumscribing projection.

19. The plastic pipe of claim 18 wherein the seal member is of a flexible material so as to be manually removable from the second end face.

20. The plastic pipe of claim 17 wherein:
the T-shaped profile defines a radially outer groove on the second end face and a radially inner groove on the second end face;
the seal member includes a first edge portion with a first finger that seats in the radially outer groove, a second edge portion with a second finger that seats in the radially inner groove and a main body portion that extends between the first edge portion and the second edge portion.

21. The plastic pipe of claim 17 wherein first end face also includes a circumscribing projection with a T-shaped profile, where the T-shaped profile of the first end face opposed the T-shaped profile of the second end face.

22. A method of joining plastic pipe ends, comprising:
utilizing a first plastic pipe having a first annular flange at one end, the first annular flange including a first end face;
utilizing a second plastic pipe having a second annular flange at one end, the second annular flange including a second end face, the second end face configured for mating with the first end face;
moving first end face and the second end face axially into mating relationship with each other;
applying a plurality of axial retention members around a perimeter of the mated first and second annular flanges to hold the pipe joint together.

23. The method of claim 22 wherein the axial retention members are formed as one of snap-fit compression clips or clamp assemblies.

24. The method of claim 22 wherein in the mating relationship the first end face engages a first sealing face of an annular seal member and the second end face engages a second sealing face of the annular seal member.

25. The method of claim 22 wherein at least one of the first end face and the second end face includes a seal member mounted thereon, and the seal member is at least partially compressed between the first end face and the second end face when the compression clips are applied.
